(19) United States
(12) Patent Application Publication
(10) Pub. No.: US 2011/0048876 A1
(43) Pub. Date: Mar. 3, 2011

(54) Adaptive Profile Brake Arrangement

(76) Inventor: Allen Paul Bujak, Howell, MI (US)

(21) Appl. No.: 12/224,573

(22) PCT Filed: Mar. 1, 2007
(86) PCT No.: PCT/US07/05310

§ 371 Date: Aug. 28, 2008

Related U.S. Application Data
(60) Provisional application No. 60/778,631, filed on Mar. 1, 2006.

(51) Int. Cl. F16D 65/12

(52) U.S. Cl. 188/218 XL

(57) ABSTRACT

A brake rotor for the braking system of a vehicle is provided with a plurality of slots machined into the brake plate of a vented or solid brake rotor. The slots have a circular cross section, and are limited to depth corresponding to the wear limit of the rotor. The slots may be oriented in a wide variety of configurations, and preferably are curved and distributed over the rotor surfaces so as not to overlap transaxially between the inboard and outboard brake plates. The slots facilitate the cleaning of the braking pads as well as provide indication of rotor wear.

### BACKGROUND OF THE INVENTION

1. Field of the Invention

This invention relates generally to brake rotors and more particularly to a brake rotor arrangement that has provided thereon slots that are configured to improve the cleaning of the brake pad surface and reduce rotor deformation and degradation during brake usage.

2. Description of the Related Art

Most brake rotor arrangements in use on commercially available vehicles have relatively smooth and continuous braking surfaces on the rotor plates. Some brake rotors that are available for high performance conditions have ventilation channels arranged between the opposing rotor faces, and yet others have slots cut into the rotor faces themselves.

The current use of slots in the rotor faces of commercially available brake rotors does not address many of the problems associated with current vehicle braking systems. For example, as vehicle brakes are used, dirt, debris, and particles that have been worn off of the brake pads are accumulated on the pad, including the region of interface between the brake pad and the rotor causing significant degradation in braking performance. There is a need, therefore, for a braking arrangement that diminishes the adverse effects of such accumulation of foreign matter.

In addition to the foregoing, it is difficult to determine the extent of rotor wear on a smooth rotor surface without disassembly and inspection of the braking system. This is costly and usually results in neglect of necessary maintenance until catastrophic failure is imminent. Even braking rotors that are slotted through fail to provide a readily discernible visual indication of wear.

There is additionally a need to reduce the effects of braking rotor run out and variation in thickness that results from repeated heating and cooling of the rotor during usage. Such variations in rotor dimensions cause dangerous uneven and pulsed braking characteristics to occur and the resulting uneven distribution of heat applied to the rotor causes further warping of the rotor and aggravates the undesirable braking condition.

It is, therefore, an object of this invention to provide a rotor for a vehicle braking system that facilitates the self-cleaning of a disc brake pad.

It is another object of this invention to provide a rotor for a vehicle braking system that facilitates the determination of wear of the rotor upon visual examination without the need for disassembly of the system or measurement of the thickness of the disassembles rotor.

It is also an object of this invention to provide a rotor for a vehicle braking system that reduces braking rotor run out and variation in thickness that would result from braking usage.

It is a further object of this invention to provide a rotor for a vehicle braking system that diminishes the development of uneven braking characteristics during braking usage.

It is yet another object of this invention to provide a rotor for a vehicle braking system that readily can be installed in pre-existing vehicle braking systems.

It is a still further object of this invention to provide a rotor for a vehicle braking system that is visually appealing and that enhances the appearance of a vehicle on which it is installed.

Another object of the invention is to provide a methodology for designing slots that are cut into the braking surface of a brake rotor.

### SUMMARY OF THE INVENTION

The foregoing and other objects are achieved by this invention which provides a brake rotor of the type having axially opposing inboard and outboard rotor faces. In accordance with the invention, the brake rotor is provided with at least first and second slots cut into the outboard rotor face. The first slot in this embodiment of the invention has a depth characteristic that is determined in relation to a predetermined useful life of the brake rotor.

In a specific illustrative embodiment of the invention, the first slot is dimensioned to be sufficiently large to enable unaided visual inspection thereof.

In a further embodiment, there is additionally provided at least first and second slots cut into the inboard rotor face. The first and second slots that are cut into the inboard rotor face are distributed on the inboard rotor face to preclude transaxial interference with the first and second slots cut into the outboard rotor face.

In a preferred embodiment of the invention, there are provided equal pluralities of slots cut into the inboard and outboard rotor faces and distributed equiangularly on the first and second rotor faces to preclude transaxial interference between the slots cut into the respective inboard and outboard rotor faces, for defining respective rotor segments. The respective rotor segments are angularly determined to deform independently of on another other in response to brake usage.

In other embodiments, the pluralities of slots cut into the inboard and outboard rotor faces are all of equal depth. Preferably, the depth of each such cut is determined in relation to a predetermined useful life of the brake rotor. Each of the slots of the pluralities of slots cut into the inboard and outboard rotor faces has an elongated arcuate configuration, and has a radially determined cross-sectional configuration. Such slots can additionally be configured to effect a balancing of the brake rotor.

The rotor wear characteristics of the rotor of the present invention are improved throughout the useful rotor life by the slots therein provided that enable continuous cleaning of the brake pad surface. In addition, at least some of the slots are configured to have a depth into the rotor surface that will provide a visual indication of rotor wear, and preferably an indication that the rotor must be replaced. In a preferred embodiment of the invention, where the slots are rotor wear indicators, the slot depth is determined in relation to useful rotor life. Thus, when the slot disappears, visual indication is provided that the rotor must be replaced.

In addition to the foregoing, rotor performance is improved in the rotor of the present invention by achieving a reduction in rotor run out and thickness variation. The rotor of the present invention demonstrates less performance degradation than a rotor with unslotted brake plates. The slots of the present invention enable the brake plate sections to deform independently of each other, and therefore adapt better to brake usage.

It is a particular advantage of the present invention that the slots are easily manufactured and can be added to existing designs via a variety of methods. The slot pattern results in an aesthetic improvement over a conventional plain rotor, and is highly desirable for use in performance vehicles.

In accordance with a further apparatus aspect of the invention, there is provided a brake rotor of the type having axially opposing inboard and outboard rotor faces, the brake rotor having first and second slots cut into the rotor face. The first and second slots each have radially inner and radially outer end points that define respective slot angle sweeps with respect to a brake plate center, and angles of attack with respect to radially inner tangential references that intersect with the respective radially inner end points thereof, the angles of attack each being within a range of approximately between 15° and 54°, the first and second slots having respective slot depths that are less than a predetermined maximum wear characteristic of the brake rotor.

In one embodiment of this further apparatus aspect of the invention, the predetermined maximum wear characteristic of the brake rotor is determined in relation to a predetermined useful life of the brake rotor. The first and second slots are each additionally configured to have a slot width that is less than 3 mm.

The radially inner and radially outer end points of the first slot are, in one embodiment, located on the braking surface of the brake rotor. In other embodiments, however, at least one of the radially inner and radially outer end points of the first slot is located off of the braking surface of the brake rotor.

In accordance with a method aspect of the invention, there is provided a method of designing a slot for the braking surface of a brake rotor. The method is provided with the steps of:

identifying a Y-axis reference line that extends radially from a center point of the brake rotor;

identifying an X-axis reference line that extends radially from a center point of the brake rotor, and is arranged orthogonal to the Y-axis reference line;

defining a first end point of the slot on the Y-axis reference line;

defining a tangential reference line that intersects the first end point of the slot on the Y-axis reference line and that is orthogonal to the Y-axis reference line;

defining a second end point of the slot;

establishing an end points reference line that is defined by the intersection of the first and second end points, and maintaining an angle of attack between the end points reference line and the tangential reference line to within 15 and 54; and

establishing a depth characteristic for the slot that is less than a predetermined maximum wear characteristic of the brake rotor.

In one embodiment of the method aspect of the invention, there is provided the further step of establishing a cross-sectional contour characteristic for the slot that is substantially rounded. Such a rounded contour will reduce the likelihood of developing cracks in the brake rotor.

In a further embodiment, at feast one of the first and second end points is disposed off of the braking surface of the brake rotor. In such an embodiment, the step of establishing an end points reference is defined by the point where a center line of the slot intersects a selectable one of an innermost and outermost circumference of the braking surface of the brake rotor. In some embodiments, both end points are disposed off of the braking surface of the brake rotor.

In still further embodiment, there is provided the further step of establishing a cross-sectional width characteristic of the slot that is less than or equal to 3 mm with respect to the braking surface of the brake rotor. There is provided in other embodiments the further step of disposing the first and second slots in diametrical opposition to one another on the braking surface of the brake rotor. Additionally, in embodiments where the brake rotor has a further braking surface, a slot can be cut thereon in accordance with inventive methodology herein described.

### BRIEF DESCRIPTION OF THE DRAWING

Comprehension of the invention is facilitated by reading the following detailed description, in conjunction with the annexed drawing, in which:

FIG. 1 is a simplified plan representation of a brake rotor arrangement configured with slots in accordance with the invention;

FIG. 2 is a simplified schematic representation of the embodiment of FIG. 1 further showing the relationship between the slots on both braking surfaces of the brake rotor arrangement;

FIG. 3 is an amplified representation of section 3-3 of FIG. 2;

FIG. 4 is a simplified schematic representation showing angular relationships between the slots;

FIG. 5 is a simplified schematic representation of a full width slot configuration;

FIGS. 6a and 6b are simplified graphical and cross-sectional representations, respectively, of a basic rotor slot geometry;

FIG. 7 is a graphical representation, in bar chart form, illustrating runout measurements in deflection/deformation tests of front brake rotors;

FIG. 8 is a graphical representation, in bar chart form, illustrating runout measurements in deflection/deformation tests of rear brake rotors;

FIGS. 9a and 9b are tabular representations of runout measurement data resulting from deflection/deformation tests in inboard and outboard brake plates, respectively;

FIG. 10 is a graphical representation, in bar chart form, illustrating thickness variation measurements in deflection/deformation tests of front brake rotors;

FIG. 11 is a graphical representation, in bar chart form, illustrating thickness variation measurements in deflection/deformation tests of rear brake rotors;

FIG. 12 is a tabular representation of thickness variation data acquired during a deflection/deformation test;

FIG. 13 is a graphical representation, in bar chart form, illustrating brake-plate-to-brake-plate parallelism data acquired during deflection/deformation tests of front brake rotors;

FIG. 14 is a graphical representation, in bar chart form, illustrating brake-plate-to-brake-plate parallelism data acquired during deflection/deformation tests of rear brake rotors;

FIG. 15 is a tabular representation of brake-plate-to-brake-plate parallelism numerical data acquired during deflection/deformation tests of brake rotors;

FIG. 16 is a graphical representation, in bar chart form, illustrating inboard-braking-surface-to-inboard-mounting-surface parallelism data acquired during deflection/deformation tests of front brake rotors;

FIG. 17 is a graphical representation, in bar chart form, illustrating inboard-braking-surface-to-inboard-mounting-surface parallelism data acquired during deflection/deformation tests of rear brake rotors;

FIG. 18 is a tabular representation of inboard-braking-surface-to-inboard-mounting-surface parallelism data acquired during deflection/deformation tests of rear brake rotors;

FIG. 19 is a graphical representation, in bar chart form, illustrating the results of noise evaluation tests;

FIGS. 20a and 20b are simplified representations of braking surface slots that stop short of the brake plate edge, and proceed past the brake plate edge, respectively;

FIG. 21 is a simplified schematic representation that illustrates slot-brake-plate-to-brake-plate orientation;

FIG. 22 is a tabular representation of the slot design characteristics of an idealized implementation of the present invention; and

FIGS. 23a, 23b, and 23c are simplified schematic representations of respective slot designs.

### DETAILED DESCRIPTION

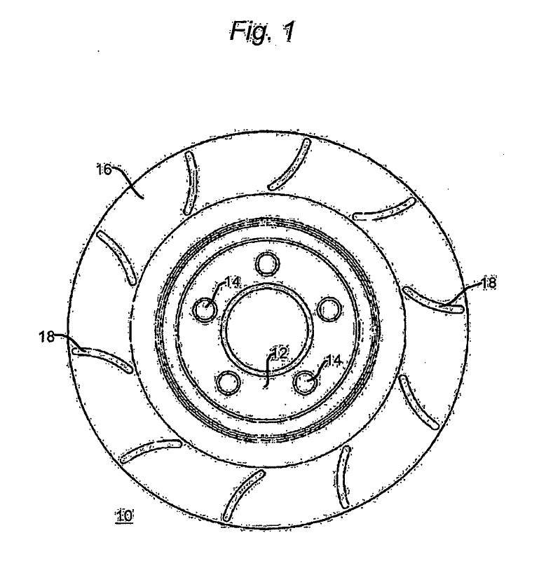

FIG. 1 is a simplified plan representation of a brake rotor arrangement 10 configured with slots in accordance with the invention. As shown in this figure, brake rotor arrangement 10 has a conventional hub region 12 through which are provided apertures 14 for mounting onto a vehicle axle (not shown). Hub region 12 has coupled at its circumference a rotor plate 16 having slots 18 therein.

Each of slots 18 has a cross section that is circular, with a radius of approximately 5 mm. In the practice of the invention, the depth of the slot is limited to the maximum wear amount of the rotor brake plates (typically 1 mm). The slots are evenly angularly spaced around the rotor face of rotor plate 16. The number of slots is dependent on the amount of frictional material refacing that is required, along with the machining method chosen.

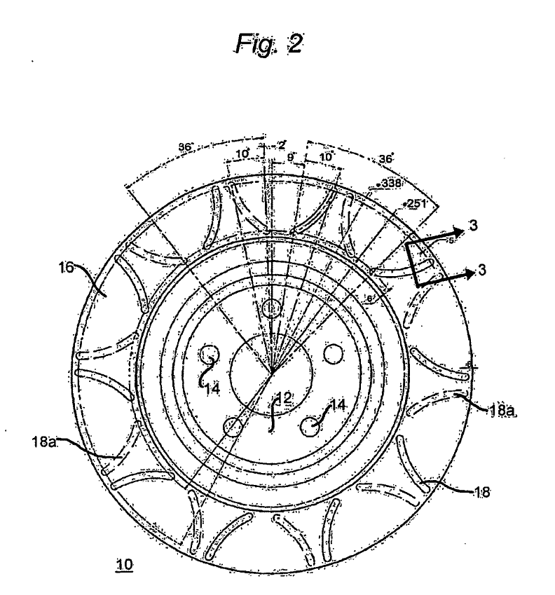

FIG. 2 is a simplified schematic representation of brake rotor arrangement 10 of FIG. 1 further showing the relationship between the slots on both braking surfaces of the brake rotor arrangement. The slots 18, and slots 18a (shown in phantom) on the opposing rotor face, as previously noted, are equiangularly spaced. However, in a preferred embodiment of the invention, slots 18 and 18a are offset enough from each other such that there is no overlap of slots on the opposing rotor faces.

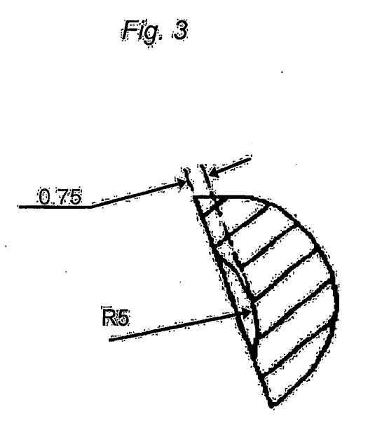

FIG. 3 is an amplified representation of section 3-3 of FIG. 2. As shown, each slot has a circular cross-section. The slots may, in certain embodiments of the invention, be milled into the rotor faces, via a set of coordinates in a CNC machine (not shown). The slots also may be cut into the brake plates on a lathe, by controlling the speed of the tool and the rotation of the part. Alternatively, the slots may be cast into the rotor plate.

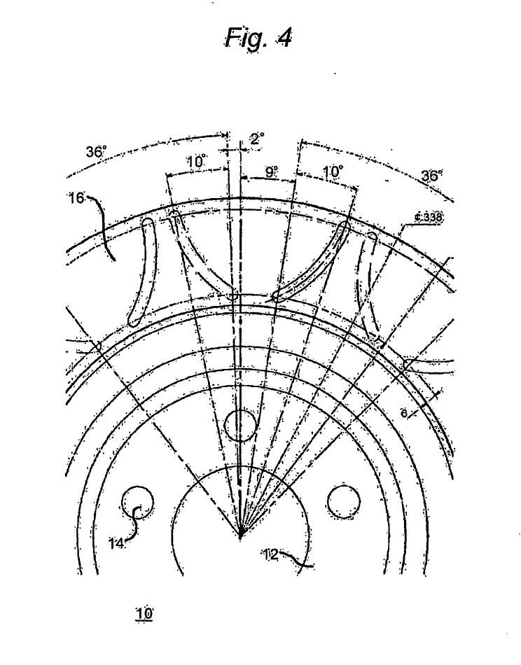

FIG. 4 is a simplified schematic representation showing angular relationships between the slots of brake rotor arrangement 10. The total angular sweep of each slot in this embodiment is approximately between 10° and 30°. In this specific illustrative embodiment of the invention, each slot is shown to extend over an angular distance of approximately 10° of arc. As shown, the angular distance between slots 18 and 18a is approximately 9° in this specific illustrative embodiment of the invention. There is therefore no transaxial overlap between the slots on opposing rotor faces of brake rotor arrangement 10.

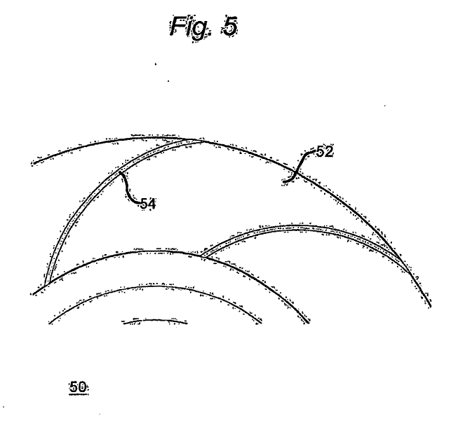

FIG. 5 is a simplified schematic representation of a brake rotor arrangement 50 having full width slots 54 configured in accordance with the invention. As shown in this figure, slots 54 may extend off brake plates (as shown). In other embodiments of the invention, the slots will extend short of the perimeter of the rotor face edge (as shown in the embodiment of FIGS. 1 and 2).

This following information and data will establish an idealized implementation of the present invention. This data is based on testing conducted by the inventor, and as will be described herein, multiple design iterations were developed and tested. The present design iterations are presented to support the conclusions set forth herein.

The Adaptive Profile Brake (APB) of the present invention is, in accordance with one aspect of the invention, a method of slotting a brake rotor that will enable the brake rotor to perform significantly better than brake rotors that do not have slots. In accordance with this method aspect, one or more slots are cut into a brake rotor braking surface. The slots may be configured to end on, or proceed off of, the brake plate surfaces. Comprehension of the detailed characteristics of the slots is facilitated by the following description of the their basic geometry.

FIGS. 6a and 6b are simplified graphical and cross-sectional representations, respectively, of a basic rotor slot geometry. As shown in these figures, two views are represented. The view of FIG. 6a is a two-dimensional representation of the slot geometry on each rotor brake plate. The view of FIG. 6b is a cross-sectional representation that indicates the slot width and the slot depth from the brake plate surface. It is to be understood that these slot representations are not to be construed as limiting the scope of potential slot designs that can be configured by person of skill in the art in view of the teaching herein.

Referring once again to FIG. 6a, both curved and linear slot outlines are depicted. The two views shown in FIG. 6a illustrate the basics of slot geometry and identify those basics in a manner that will be consistent throughout the following description. The following are featured elements of FIG. 6a:
X-Axis: This reference line is represented as horizontal, but it is simply a straight imaginary line through the center of the brake plate;
Y-Axis: This reference line is represented in the figure as vertical, and is defined to be perpendicular to the X-Axis and to intersect the center of the brake plate;
Brake Plate Center: This point is defined as the center of the brake plate outer and inner diameters in a two-dimensional view and the axis of the rotor in three dimensions;
Slot Endpoints These points are defined as the points at which a slot ends. Since, in the practice of the invention, the slots are cut into the rotor by a tool (not shown), the endpoints are established on the centerline of the slot itself and are located at the center of the cutting tool at the slot ends instead of being located at the physical limits of the slot. It should be noted that the innermost slot endpoint should rest on the Y-Axis;
Slot Sweep Angle: This represents the angular displacement from one slot endpoint to another;
Slot Endpoint Diameters: These are the diameters on which the slot endpoints rest. Although the diameters are shown to be concentric in FIG. 1, concentricity is not a requirement in the practice of the invention.
Slot Centerline: This is an imaginary reference line that is drawn from one slot endpoint to the other. While a typical centerline would be either linear or curved based on desired slot shape, for the purpose of proper design this imaginary centerline should always be linear;
Reference Line: This corresponds to an imaginary line that is perpendicular to the Y-Axis and parallel to the X-Axis, and that passes through the innermost slot endpoint;
Angle Of Attack: This corresponds to the angle between the slot centerline and the reference line; and
Slot Depth: This is the depth to which the slot is cut into the rotor brake plate. This depth is a maximum and is determined without regard of the cross-sectional configuration of the slot.

The following features and characteristics of the present invention are determined with respect to known unslotted brake rotor designs and their performance.

A first significant advantage of the inventive rotor braking system is that it will facilitate self-cleaning of the brake pad. Generally, the slot(s) on a brake plate surface will have edges that will contact and scrape the brake pad as the rotor rotates. This scraping action has the effect of cleaning the brake pad with every pass made by a slot. Because rotor rotation is a fundamental of brake system function, the cleaning action is continuous as the system operates and the brakes are applied.

In addition, the inventive rotor braking system facilitates visual determination of wear without the need for disassembly of the system. In all rotor designs, there exist critical wear criteria for brake plate thickness. Typically this critical wear is 1 mm per brake plate (2 mm for the overall brake-plate-to-brake-plate-thickness). Although slots can function at a variety of depths, slots having a depth that corresponds to, or that is less than the critical wear depth, will disappear from the rotor surface when the rotor has been fully worn. Because the slots are such a prominent feature on the brake plates, it will be obvious from a visual inspection (without removing a single component) that the slot has disappeared and therefore when the rotor has been worn down to the end of its functional life.

A further advantage of the inventive rotor braking system is that the rotor can readily be installed in existing brake systems. As noted herein, the inventive rotor braking system includes one or more slots on the rotor brake plates. Since the slots do not add material to the brake plates, and neither do they require structural changes to any other part of the rotor in order to function in accordance with the principles of the invention, the slotted rotor of the inventive rotor braking system is readily accommodated in an existing brake system. In addition, since the performance of the rotor is improved with the implementation of this invention, the enhanced performance of the inventive rotor braking system does not negatively impact rotor compatibility with the existing brake system or its components.

It is noted that the rotor of the inventive rotor braking system is visually appealing and serves to enhance the appearance of the vehicle on which it is installed. Based on the success of cross-drilled rotors for their visual appeal, and the known market studies that have been performed in relation to manufacturer's concepts and performance vehicles, slotted brake rotors represent a visual enhancement to a vehicle and is unique, interesting, and desirable.

A further advantageous and significant characteristic of the inventive rotor braking system is that the brake rotor will exhibit reduced runout and thickness variation following use. Tests on the inventive rotor braking system conducted by the inventor herein have shown the great variation in runout and thickness variation performance of various slot designs. Since the deflection/deformation test provides the best indicator of rotor deformation in service, that test was performed, as herein reported, to determine the performance of both, slotted and unslotted rotors. All of the graphical representations described in detail hereinbelow include a bar marking on each of the graphical bars that indicates the pre-test condition of the part under test. This affords a more comprehensive view of rotor performance.

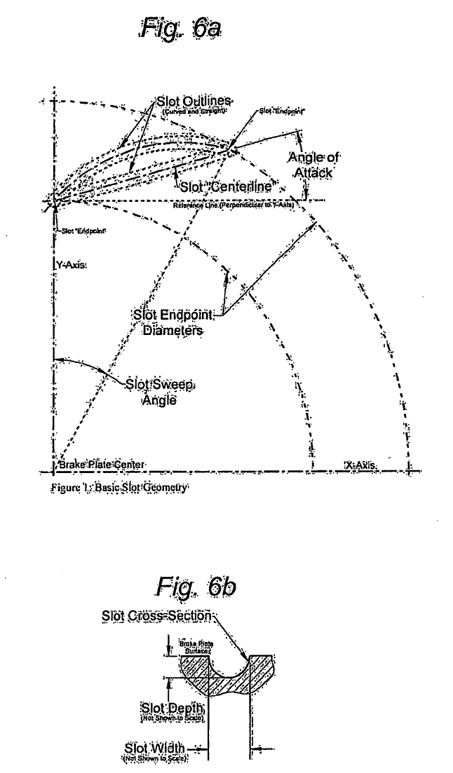

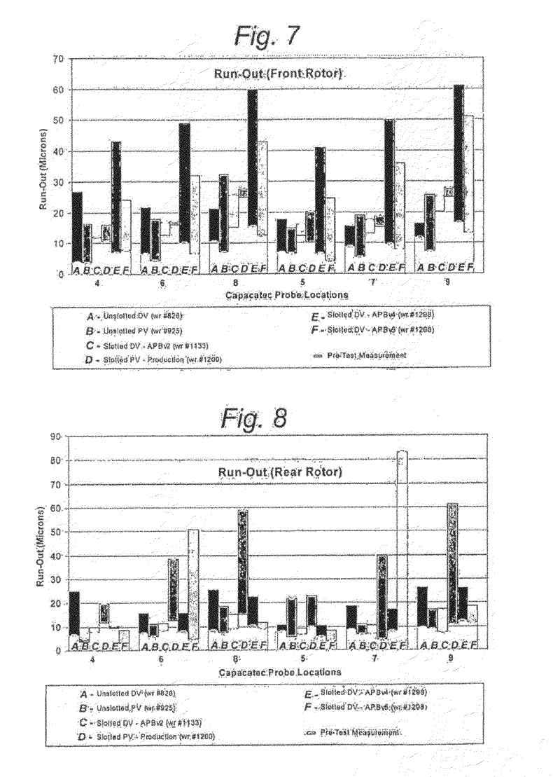

FIG. 7 is a graphical representation, in bar chart form, illustrating runout measurements in deflection/deformation tests of front brake rotors. The data represented in this figure compares run-out performance for a variety of front rotors in the deflection/deformation test. FIG. 8 is a graphical representation, in bar chart form, illustrating runout measurements in deflection/deformation tests of rear brake rotors, using the same deflection/deformation test.

In FIG. 7, a graphical bar is included at the end of each column to indicate the pre-test level of runout. For unslotted rotors, this bar is at the bottom of each column, noting that the rotors developed more runout during the test than they started with. For slotted rotors denoted as “C” (i.e., “APBv2”), the graphical columns are generally shorter than those for the unslotted rotors, indicating that those two slotted rotors developed less runout during the test. In some measurement locations the bars appear at the top of the columns, which indicates that the two slotted rotors actually had less runout after the test than they had before the test. It is this characteristic that is at the core of the APB of the present invention, since the rotor brake plates, when properly slotted, will adapt to wear conditions over the life of the rotor, instead of simply deforming.

It should also be noted that two other slot designs “E” and “F” (noted as APBv4 and APBv5, respectively) were tested and those rotors exhibited much worse behavior for runout. This indicates that there are distinct and specific characteristics in a slot design that can control or eliminate the benefit of brake plate adaptability.

With reference to FIG. 8, the same trend is largely observed as in FIG. 7. It is notable, however, is that the APBv2 (“C”) design rarely exhibits great changes in runout, while the Production (“D”) design varies to a much greater extent. It should also be noted that the APBv4 (“E”) and APBv5 (“F”) designs for the most part perform comparable to the APBv2 (“C”) and Production (“D”) designs. Also, while it can be seen in some cases that the unslotted rotors performance is much closer to the slotted designs, the rear rotor sees a much lighter duty cycle and therefore is less of an indicator of the true performance delta. Including this caveat, however, there is still a notable and significant improvement in performance in a properly slotted rotor when compared with an unslotted rotor.

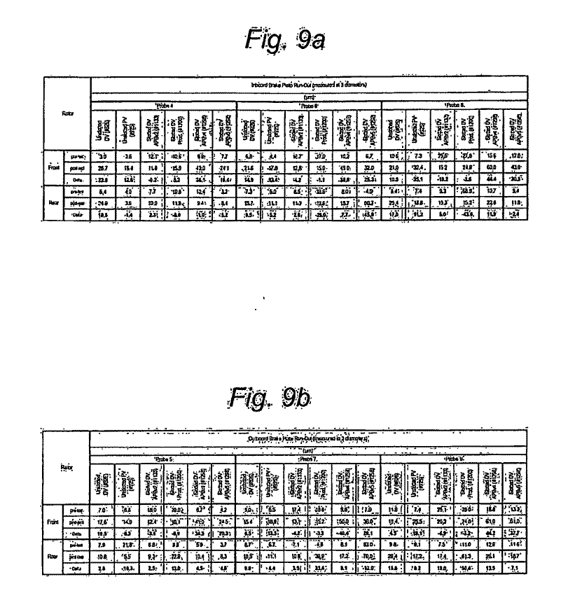

FIGS. 9a and 9b are tabular representations of runout measurement data resulting from deflection/deformation tests in inboard and outboard brake plates, respectively. The numerical data represented in these figures corresponds to the bar graphs shown in FIGS. 7 and 8.

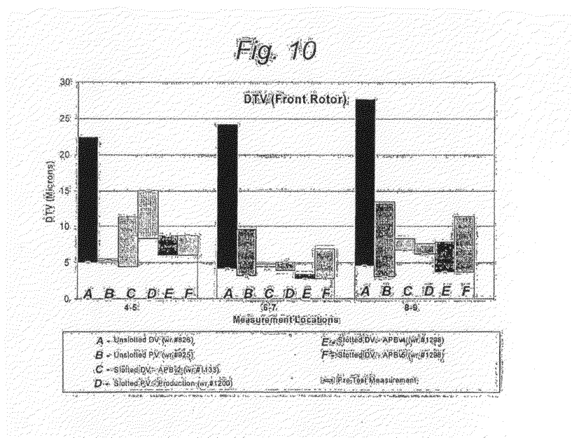

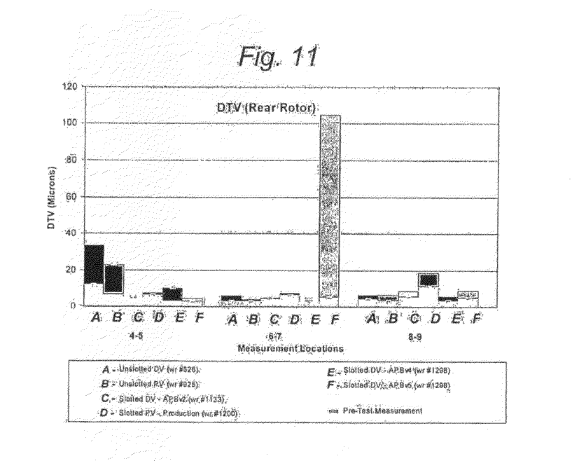

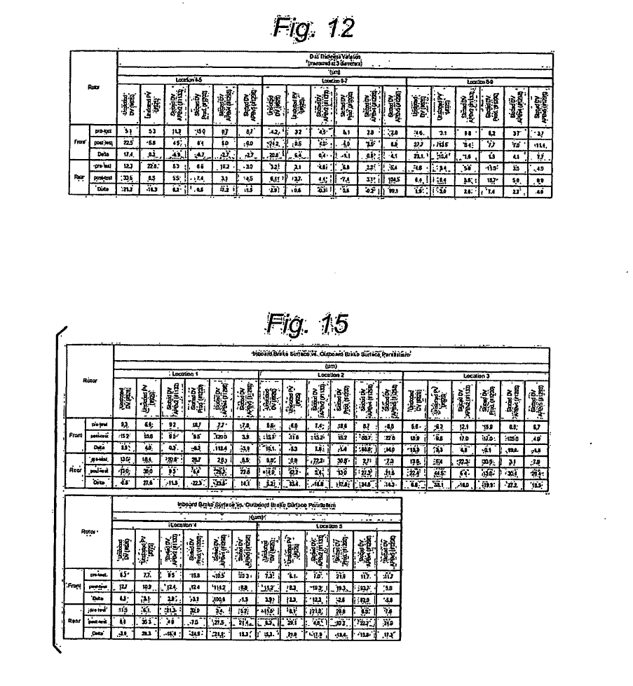

Runout is not the only measure of rotor deformation characteristics. Disc thickness variation is also critical and must also be examined. FIG. 10 is a graphical representation, in bar chart form, illustrating thickness variation measurements in deflection/deformation tests of front brake rotors. FIG. 11 is a graphical representation, in bar chart form, illustrating thickness variation measurements in deflection/deformation tests of rear brake rotors; and FIG. 12 is a tabular representation of thickness variation data acquired during a deflection/deformation test. FIGS. 10, 11, and 12 show the results of thickness variation measurements made during the deflection/deformation tests hereinabove referenced.

Most notable in FIG. 10 is that the thickness variation in all unslotted cases increases during the Deflection/Deformation test, while the slotted rotors show either greatly reduced thickness variation or even a reduction in thickness variation after the same test. It is also important to note that the performance of each slotted rotor varies, which is an indicator that a proper slot design is required to realize maximum benefits. This slot design will be addressed below.

FIG. 11 illustrates the same test with the rear rotor and for the most part displays the same trend of improved performance in the slotted rotors. There are a couple of incongruous data portions, such as the APBv5 (“F”) design showing a much higher thickness variation in one measurement location, but based on this rotor's performance in other areas (and even in other locations on the same graph of this figure) this reading is due to external factors and not the slot design itself. The two designs that performed best for runout APBv2 (“C”) and Production (“D”) also perform best here. The conclusion therefore can be drawn that a rotor that bears an idealized slot configuration will perform better than an unslotted rotor.

FIG. 12 presents in tabular form the numerical data that corresponds to the bar graphs of FIGS. 10 and 11. As this data shows, it is possible to design a slotted rotor that will greatly improve the runout and disc thickness variation that develops on every brake rotor during normal use. This data also shows that a wide range of performance is possible depending on the specific slot configuration and for that reason an ideal implementation is required and will be addressed at the conclusion of this report, based on the slot designs that were tested here.

It is a further advantageous characteristic of the inventive rotor braking system that the slotted rotor will have will have a reduced uneven braking characteristic during normal use. Uneven Braking Characteristics are described as those characteristics that affect rotor performance with respect to the brake system, unlike thickness variation and runout which, while impacting system performance, are actually measures of rotor deformation.

One characteristic that is used to measure the impact of Uneven Braking Characteristics is the measure of Inboard Brake Surface Parallelism versus Outboard Brake Surface Parallelism. This measurement reflects the extent to which each brake plate is parallel to each other. This impacts directly the orientation of the rotor to the brake pads themselves. It should be noted that this parallelism is critical and should be controlled on every brake rotor. The following figures will detail these parallelism results, also from the deflection/deformation test.

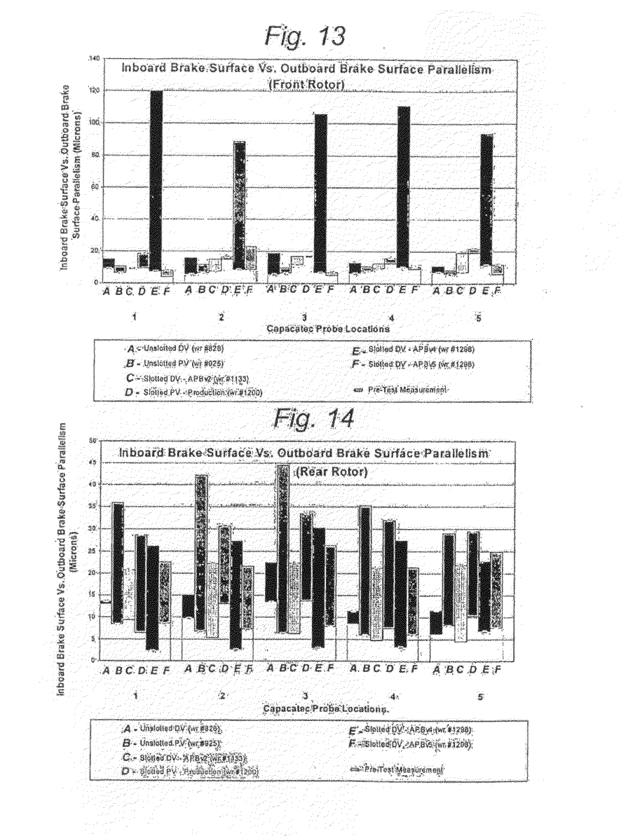

FIG. 13 is a graphical representation, in bar chart form, illustrating brake-plate-to-brake-plate parallelism data acquired during deflection/deformation tests of front brake rotors. The graph of this figure indicates that of the four slot designs tested (C, D, E, and F), three (C, D, and F) perform better than unslotted rotors. Those three slotted rotors all either developed less growth in unparallelism or actually had their unparallelism drop from the beginning of the test to the end (behavior not seen in unslotted rotors). The poor performance of the APBv4 (“E”) rotor is evidence that the parallelism between the brake plates can be controlled with a proper slot design.

FIG. 14 is a graphical representation, in bar chart form, illustrating brake-plate-to-brake-plate parallelism data acquired during deflection/deformation tests of rear brake rotors. This figure dramatically emphasizes the improved performance of the slotted rotors. The two unslotted rotors exhibit extreme increases in parallelism growth from the beginning to the end of the test. The slotted rotors APBv2 (“C”) and Production (“D”) also exhibit extreme changes in brake plate parallelism, but for those two slot designs the parallelism actually decreases significantly over the course of the test. It is also again evident from the APBv4 (“E”) and APBv5 (“F”) designs that improper slot design can eliminate the performance benefit that is possible.

FIG. 15 is a tabular representation of brake-plate-to-brake-plate parallelism numerical data acquired during deflection/deformation tests of brake rotors. The data in this figure is the numerical data that corresponds to the graphical representation of FIGS. 13 and 14, and supports the trends observed in both of those charts.

A further characteristic that is used measure the impact of the rotor on the brake system is Inboard Brake Surface Parallelism versus Inboard Mounting Surface Parallelism. This determines brake plate orientation with respect to the rotor mounting face and therefore the interface with the brake system itself.

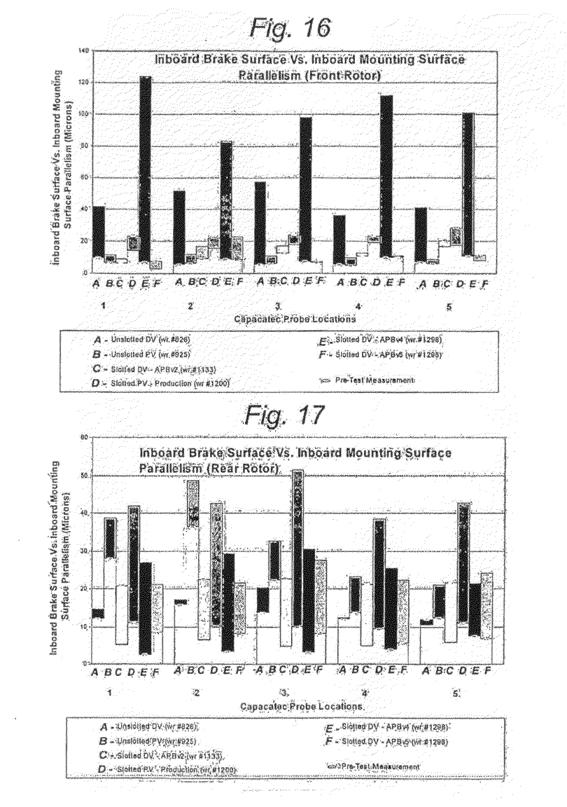

FIG. 16 is a graphical representation, in bar chart form, illustrating inboard-braking-surface-to-inboard-mounting-surface parallelism data acquired during deflection/deformation tests of front brake rotors. The figure illustrates that the Inboard Brake Surface versus Inboard Mounting Surface Parallelism for the front rotor based on the Deflection/Deformation test. This chart clearly shows significant differences between unslotted parts, but in all cases there is positive growth of unparallelism during the test, and in the case of one rotor (E) the unparallelism is always severe.

In the case of slotted rotors, again it is apparent that improperly designed slotted rotors can exhibit performance that is worse than even an unslotted rotor. However, it is additionally apparent that a properly designed rotor will have significantly better performance than an unslotted rotor. More specifically, it can be seen that the APBv2 (“C”) and Production (“D”) rotors have either minimal growth of unparallelism or a diminishing of unparallelism from the beginning of the test until the end. This clearly indicates that the rotor does indeed adapt to the deformation that it experiences during normal use.

FIG. 17 is a graphical representation, in bar chart form, illustrating inboard-braking-surface-to-inboard-mounting-surface parallelism data acquired during deflection/deformation tests of rear brake rotors. The figure illustrates the brake-plate-to-mounting-surface parallelism for a rear rotor during the deflection/deformation test. It is shown in this figure that while there is again variance between the unslotted rotors, they still display the characteristic of increasing unparallelism as the test goes on.

In FIG. 17, there is shown far more variance among the slotted designs when compared to FIG. 16, but it can be seen that the invention herein disclosed achieves significant reduction in parallelism numbers with a properly designed slot. It should be noted that while all the rotors tested are within the range of acceptable performance, reducing parallelism to the levels shown by the APBv2 (“C”) design would enable the rotor to experience a heavier duty cycle and would enable the rotor to perform better throughout its entire life.

FIG. 18 is a tabular representation of inboard-braking-surface-to-inboard-mounting-surface parallelism data acquired during deflection/deformation tests of rear brake rotors. This figure shows the numerical data from which the charts in FIGS. 16 and 17 are derived.

A still further characteristic of rotor performance that is measured at the system level is that of noise and/or vibration. This measure is difficult to capture with laboratory testing, and is almost impossible to correlate to “real world”, i.e., on vehicle performance, even if problems are found in the lab. As a result of these difficulties, vehicle testing is performed in order to arrive at an ideal implementation for this invention that produces no vibration or noise.

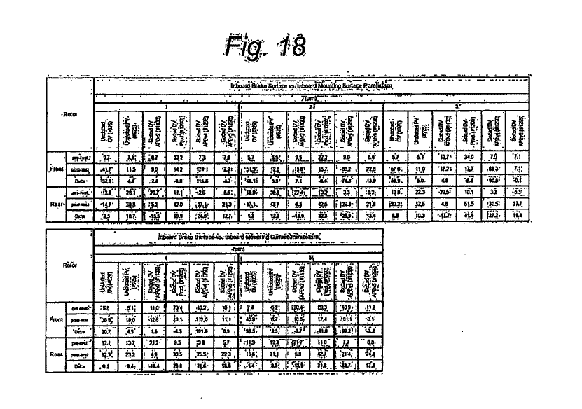

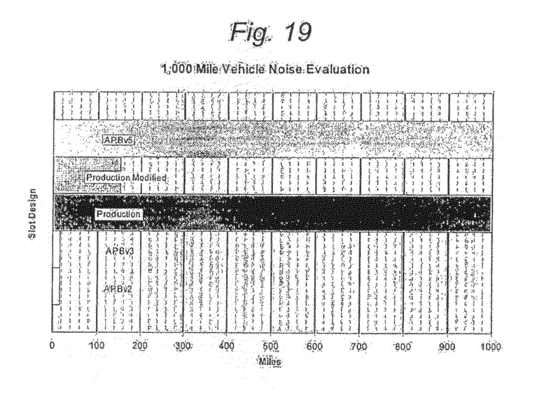

FIG. 19 is a graphical representation, in bar chart form, illustrating the results of noise evaluation tests. The figure shows the results of a 1,000 mile vehicle test that has been performed to evaluate different slot designs for vibration and noise. It is seen from this figure that slots can be designed to perform well in regard of deformation, but will perform poorly from the standpoint of vibration and/or noise on an actual vehicle. Conversely, some rotors that performed poorly for deformation can do very well for noise and vibration. The Production designs illustrate that a compromise can be achieved between both, deformation performance and vehicle performance, and consideration of this compromise is useful in the idealized implementation of the present invention.

Although the present invention can be characterized as one or more slots cut into a brake rotor's braking surfaces, it is seen hereinabove that there are distinct performance advantages to slots designed within specific characteristics. The following will establish criteria that will ensure best performance for a slotted rotor, while at the same time allowing that other configurations are possible and depending on the specific application may even be desirable. This idealized implementation also allows that there may be other constraints specific to an application that may impose other restrictions on slot design, and it is further understood that such additional constraints are too numerous to list here.

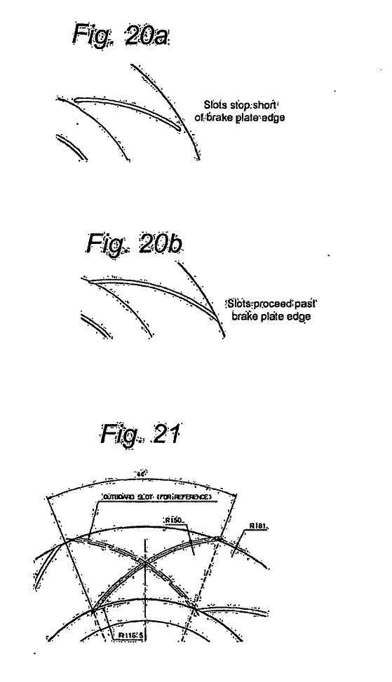

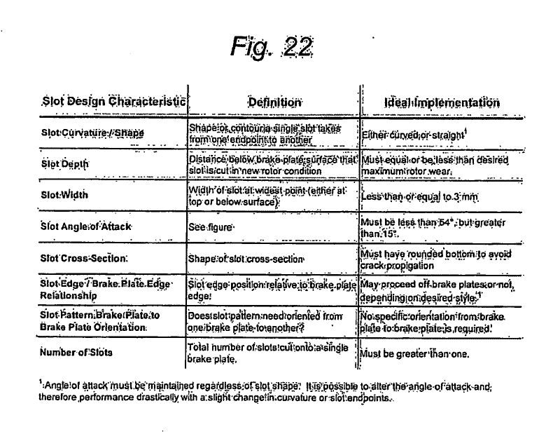

FIGS. 20a and 20b are simplified representations of braking surface slots that stop short of the brake plate edge, and proceed past the brake plate edge, respectively. FIG. 21 is a simplified schematic representation that illustrates slot-brake-plate-to-brake-plate orientation. FIGS. 1a, 1b, 20a, 20b, and 21 describe the basic slot characteristics that are needed to define the idealized implementation in accordance with th invention. Based on the designs tested and the results presented hereinabove, the idealized implementation of the slot design consistent with the claims outlined above is outlined in FIG. 22, as described herein below.

FIG. 22 is a tabular representation of the slot design characteristics of an idealized implementation of the present invention. Among the most critical characteristics of a slot design is the Angle of Attack. It is critical to note that the Angle of Attack can be critically altered by only a slight change in curvature and slot endpoints if the defined slot “centerline” as defined in FIG. 1a, is not strictly observed.

As indicated in the tabular data of FIG. 22, slot curvature and shape is not considered to have a significant impact on the performance of the brake rotor. However, the slot depth should be kept to equal or less than the predetermined maximum rotor wear. The slot width should be equal or less than 3 mm, and the angle of attack should be within 15° and 54°. The likelihood of cracking of the brake rotor is reduced by ensuring that the bottom of the slot is rounded, substantially as shown in FIG. 6b. The end points of the slots, as defined in FIG. 6a, can be either on or off of the surface of the brake rotor. Finally, the practice of the invention requires that there be at least two slots on the slotted surface of the brake rotor.

It is to be noted that rotor characteristics and overall performance are critical to controlling the sensitivity of the rotor to slotting. If a rotor shows a propensity to deformation, vibration or noise, slotting may help control such behavior, but it is possible for a rotor to exhibit these characteristics to such a degree that adding slots might not achieve the desired results. Also, there exist applications for which it may be necessary or desirable to deviate from the ideal implementation outlined in FIG. 22. Persons of skill in the art can, in light of the teaching herein, identify such applications and determine the extent to which the application of the principles of the present invention will achieve acceptable results

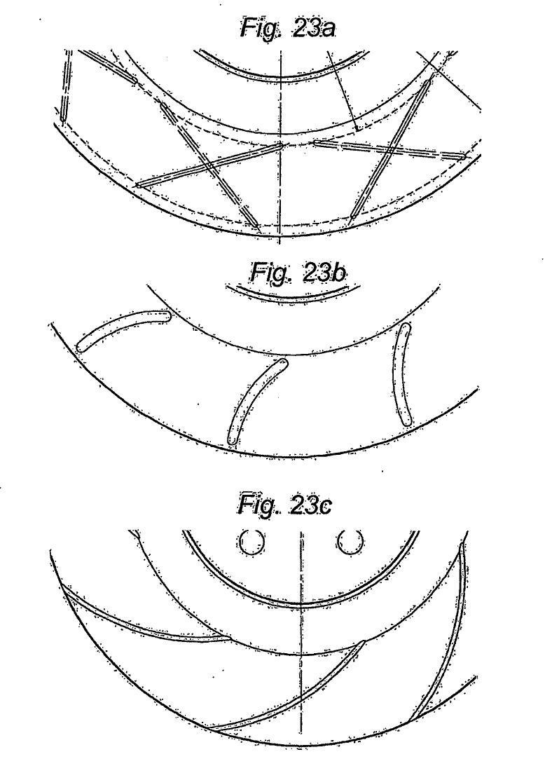

FIGS. 23a, 23b, and 23c are simplified schematic representations of respective slot designs. These figures show respective examples of slot designs. However, these examples do not constitute an exhaustive guide, as they are not intended to show every possible configuration contained within the scope of the present invention.

FIG. 23a illustrates a slot design wherein the slots are linear. Additionally, the slots of the two braking surfaces are shown to interstice one another. The end points of the slots are within predetermined circumferences, as described hereinabove in connection with FIG. 1a.

FIG. 23b illustrates curved slots on the braking surface. These slots are represented as remaining in their entirety within the braking surface. The slots of FIG. 23c, on the other hand, extend beyond the circumferential limits of the braking surface.

Although the invention has been described in terms of specific embodiments and applications, persons skilled in the art may, in light of this teaching, generate additional embodiments without exceeding the scope or departing from the spirit of the invention described and claimed herein. Accordingly, it is to be understood that the drawing and description in this disclosure are proffered to facilitate comprehension of the invention, and should not be construed to limit the scope thereof.

What is claimed is:

1. A brake rotor of the type having axially opposing inboard and outboard rotor faces, the brake rotor comprising at least first and second slots cut into the outboard rotor face, said first slot having a depth characteristic that is determined in relation to a predetermined useful life of the brake rotor.

2. The brake rotor of claim 1, wherein said first slot is dimensioned to enable visual inspection thereof.

3. The brake rotor of claim 1, wherein there is additionally provided at least first and second slots cut into the inboard rotor face, said first and second slots cut into the inboard rotor face being distributed on the inboard rotor face to preclude transaxial interference with said first and second slots cut into the outboard rotor face.

4. The brake rotor of claim 1, wherein there are provided equal pluralities of slots cut into said inboard and outboard rotor faces and distributed equiangularly on said first and second rotor faces to preclude transaxial interference between the slots cut into the respective inboard and outboard rotor faces, for defining respective rotor segments.

5. The brake rotor of claim 4, wherein said respective rotor segments are angularly determined to deform independently of on another other in response to brake usage.

6. The brake rotor of claim 4, wherein said pluralities of slots cut into said inboard and outboard rotor faces are all of equal depth, the depth being determined in relation to a predetermined useful life of the brake rotor.

7. The brake rotor of claim 4, wherein each of the slots of said pluralities of slots cut into said inboard and outboard rotor faces has an elongated arcuate configuration.

8. The brake rotor of claim 4, wherein each of the slots of said pluralities of slots cut into said inboard and outboard rotor faces has a radially determined cross-sectional configuration.

9. The brake rotor of claim 4, wherein the depth of each of the slots of said pluralities of slots cut into said inboard and outboard rotor faces is determined to effect a balancing of the brake rotor.

10. A brake rotor of the type having axially opposing inboard and outboard rotor faces, the brake rotor comprising first and second slots cut into at least one of the rotor faces, said first and second slots each having radially inner and radially outer end points that define respective slot angle sweeps with respect to a brake plate center, and angles of attack with respect to radially inner tangential references that intersect with the respective radially inner end points thereof, the angles of attack each being within a range of approximately between 15° and 54°, said first and second slots having respective slot depths less than a predetermined maximum wear characteristic of the brake rotor.

11. The brake rotor of claim 10, wherein the predetermined maximum wear characteristic of the brake rotor is determined in relation to a predetermined useful life of the brake rotor.

12. The brake rotor of claim 10, wherein said first and second slots each have a slot width that is less than 3 mm.

13. The brake rotor of claim 10, wherein the radially inner and radially outer end points of said first slot are located on the braking surface of the brake rotor.

14. The brake rotor of claim 10, wherein at least one of the radially inner and radially outer end points of said first slot is located off of the braking surface of the brake rotor.

15. A method of designing a slot for the braking surface of a brake rotor, the method comprising the steps of:
identifying a Y-axis reference line that extends radially from a center point of the brake rotor;
identifying an X-axis reference line that extends radially from a center point of the brake rotor, and is arranged orthogonal to the Y-axis reference line;
defining a first end point of the slot on the Y-axis reference line;
defining a tangential reference line that intersects the first end point of the slot on the Y-axis reference line and that is orthogonal to the Y-axis reference line;
defining a second end point of the slot;
establishing an end points reference line that is defined by the intersection of the first and second end points, and maintaining an angle of attack between the end points reference line and the tangential reference line to within 15° and 54°; and
establishing a depth characteristic for the slot that is less than a predetermined maximum wear characteristic of the brake rotor.

16. The method of claim 15, wherein there is further provided the step of establishing a cross-sectional contour characteristic for the slot that is substantially rounded.

17. The method of claim 15, wherein at least one of said first and second end points is disposed off of the braking surface of the brake rotor, and said step of establishing an end points reference is defined by the point where a center line of the slot intersects a selectable one of an innermost and outermost circumference of the braking surface of the brake rotor.

18. The method of claim 15, wherein there is further provided the step of establishing a cross-sectional width characteristic of the slot that is less than or equal to 3 mm with respect to the braking surface of the brake rotor.

19. The method of claim 15, wherein there is provided the further step of disposing the first and second slots in diametrical opposition to one another on the braking surface of the brake rotor.

20. The method of claim 15, wherein the brake rotor has a further braking surface, and there is provided the further step of designing a slot for the further braking surface of the brake rotor.
